(19) United States
(12) Patent Application Publication
(10) Pub. No.: US 2026/0202225 A1
(43) Pub. Date: Jul. 16, 2026

(54) Sensor Module

(71) Applicant: SEIKO EPSON CORPORATION, Tokyo (JP)

(72) Inventor: Ryohei OZAWA, Shiojiri (JP)

(21) Appl. No.: 19/444,676

(22) Filed: Jan. 9, 2026

(30) Foreign Application Priority Data
Jan. 10, 2025 (JP) 2025-004171

(51) Int. Cl. G01D 11/24

(52) U.S. Cl. CPC G01D 11/245

(57) ABSTRACT

A sensor module including a base and a lid constituting a housing, a sensor substrate that is disposed in the housing and on which a first sensor is mounted, two or more fixing members that fix the sensor substrate to the base, and a filling member that covers the sensor substrate and the two or more fixing members and with which a portion between the sensor substrate and the housing is filled.

The present application is based on, and claims priority from JP Application Serial Number 2025-004171, filed January 10, 2025, the disclosure of which is hereby incorporated by reference herein in its entirety.

### BACKGROUND

### 1. TECHNICAL FIELD

The present disclosure relates to a sensor module.

### 2. Related Art

A sensor module in which an inertial sensor that detects inertia based on a predetermined detection axis is mounted is known.

For example, JP-A-2017-20829 describes a sensor unit including a sensor module that includes a substrate on which an inertial sensor is mounted and an inner case in which the substrate is mounted, and an outer case that accommodates the sensor module. A recess is formed in the inner case, the inertial sensor is disposed in a region overlapping with the recess in plan view in a thickness direction of the substrate, a space formed by the substrate and the recess is filled with a filling member, and the sensor module is bonded to a bottom wall of the outer case via a bonding member.

In a case where the substrate on which the inertial sensor described above is mounted is fixed to the inner case via the filling member, there is a concern that the substrate is distorted according to an external environment such as heat or moisture.

### SUMMARY

According to an aspect of the present disclosure, a sensor module includes a base and a lid constituting a housing, a sensor substrate that is disposed in the housing and on which a first sensor is mounted, two or more fixing members that fix the sensor substrate to the base, and a filling member that covers the sensor substrate and the two or more fixing members and with which a portion between the sensor substrate and the housing is filled.

### BRIEF DESCRIPTION OF THE DRAWINGS

FIG. 1 is a perspective view schematically illustrating a sensor module according to a present embodiment.

FIG. 2 is a perspective view schematically illustrating the sensor module according to the present embodiment.

FIG. 3 is a perspective view schematically illustrating the sensor module according to the present embodiment.

FIG. 4 is a perspective view schematically illustrating the sensor module according to the present embodiment.

FIG. 5 is a plan view schematically illustrating the sensor module according to the present embodiment.

FIG. 6 is a bottom view schematically illustrating the sensor module according to the present embodiment.

FIG. 7 is a sectional view schematically illustrating the sensor module according to the present embodiment.

FIG. 8 is a sectional view schematically illustrating the sensor module according to the present embodiment.

FIG. 9 is a perspective view schematically illustrating a sensor module according to a modification of the present embodiment.

### DESCRIPTION OF EMBODIMENTS

Hereinafter, a preferred embodiment of the present disclosure will be described in detail with reference to the drawings. Further, the embodiment to be described below does not inappropriately limit the contents of the present disclosure described in the claims. In addition, all of the configurations described below are not necessarily essential components of the present disclosure.

### 1. Sensor Module

### 1.1. Configuration

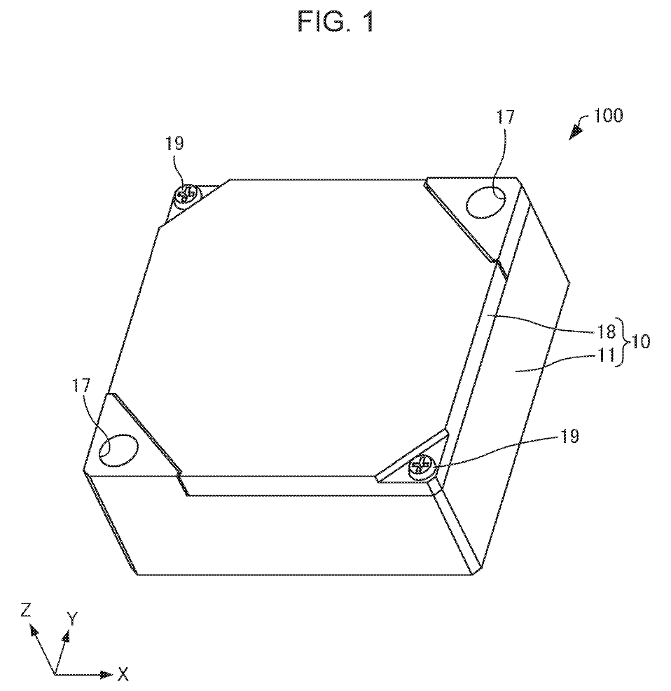

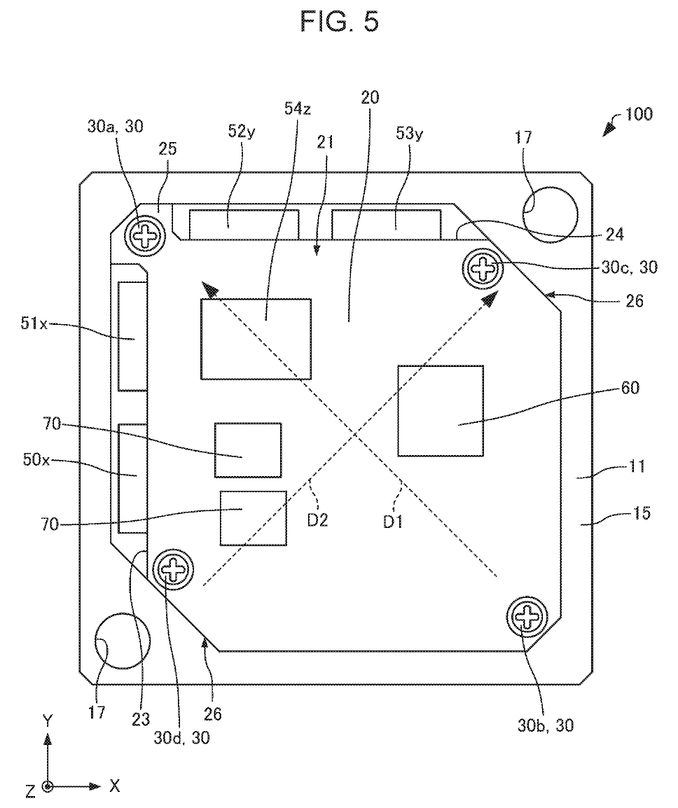

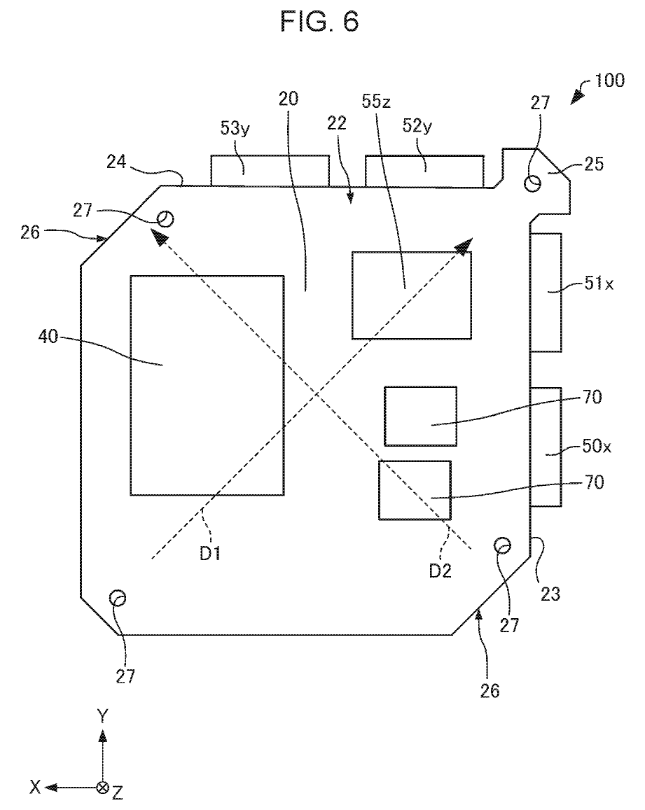

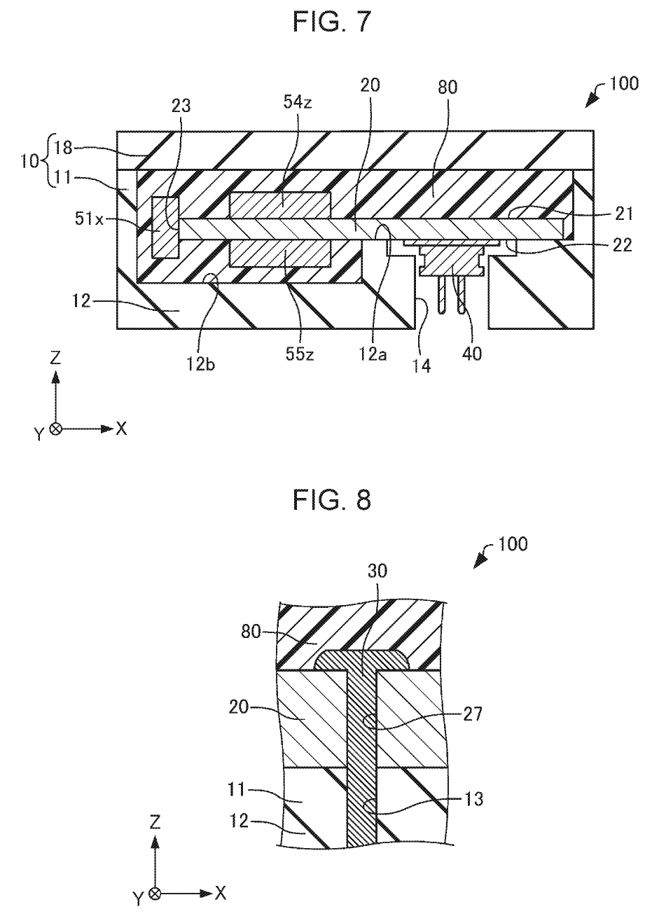

First, a sensor module according to the present embodiment will be described with reference to the drawings. FIGS. 1 to 4 are perspective views schematically illustrating a sensor module 100 according to the present embodiment. FIG. 5 is a plan view schematically illustrating the sensor module 100 according to the present embodiment. FIG. 6 is a bottom view schematically illustrating the sensor module 100 according to the present embodiment. FIGS. 7 and 8 are sectional views schematically illustrating the sensor module 100 according to the present embodiment. In FIGS. 1 to 8, an X-axis, a Y-axis, and a Z-axis are illustrated as three axes orthogonal to each other.

The sensor module 100 is an inertial measurement sensor unit (inertial measurement unit (IMU)) that detects a posture or a behavior of a mounted body such as an automobile or a robot. The mounted body is not limited to a moving body such as an automobile or a robot, and may be, for example, a building such as a bridge, an elevated structure, or a track. When the sensor module 100 is installed in a building, the sensor module 100 is used as a structural health monitoring system to check the soundness of the building.

As illustrated in FIGS. 1 to 8, the sensor module 100 includes, for example, a housing 10, a sensor substrate 20, fixing members 30, a connector 40, a first X-axis angular velocity sensor 50x, a second X-axis angular velocity sensor 51x, a first Y-axis angular velocity sensor 52y, a second Y-axis angular velocity sensor 53y, a first Z-axis angular velocity sensor 54z, a second Z-axis angular velocity sensor 55z, a circuit element 60, acceleration sensors 70, and a filling member 80.

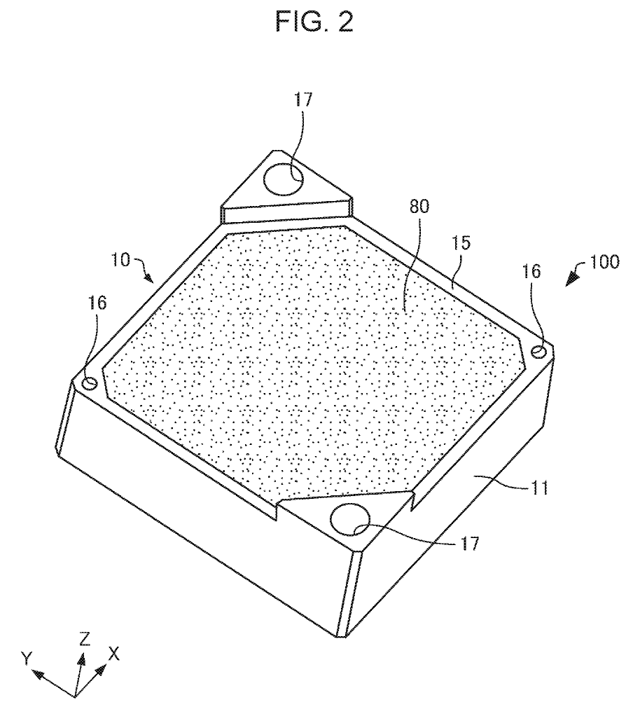

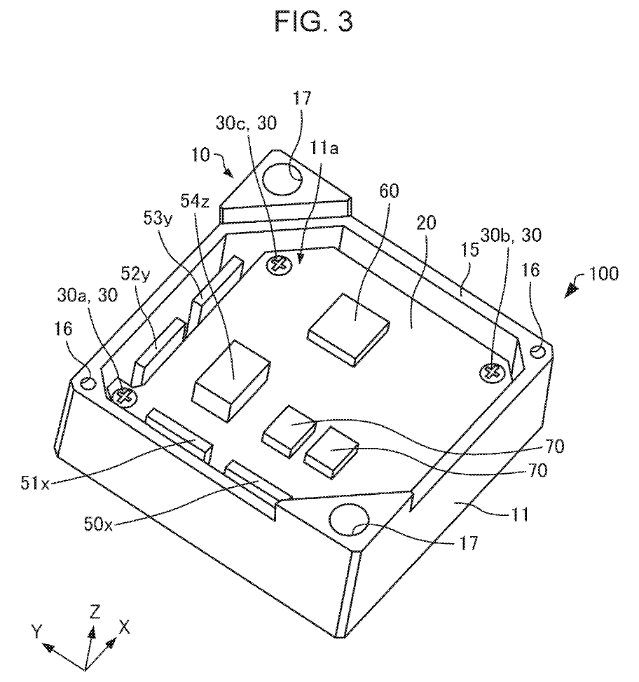

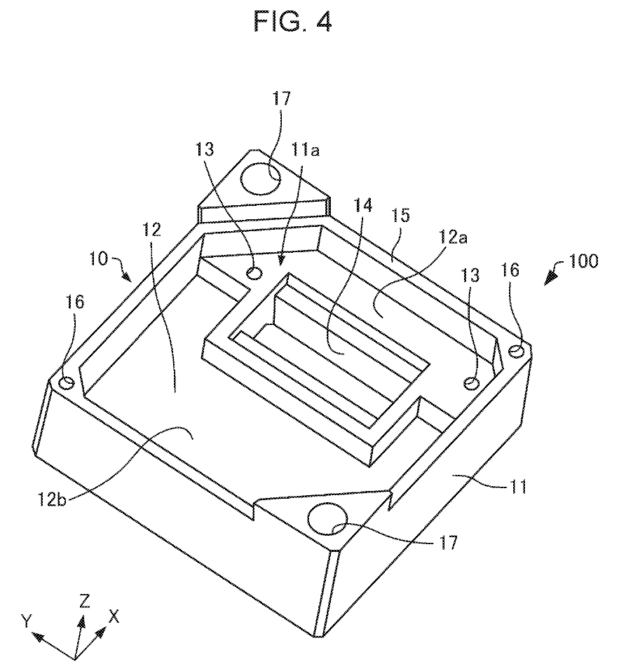

For convenience, a lid 18 of the housing 10 is not illustrated in FIG. 2. In FIG. 3, the lid 18 and the filling member 80 are not illustrated. In FIG. 4, members other than a base 11 of the housing 10 are not illustrated. In FIG. 5, the lid 18 and the filling member 80 are not illustrated. In FIG. 6, components other than the sensor substrate 20 and components mounted on the sensor substrate 20 are not illustrated.

The housing 10 accommodates the sensor substrate 20. The material of the housing 10 is, for example, aluminum. As a result, the housing 10 has high rigidity. An alumite process may be performed on the surface of the housing 10. As a result, the housing 10 has an insulating property. The material of the housing 10 is not particularly limited, and may be, for example, a metal such as titanium, magnesium, or stainless steel, a ceramic such as alumina or titania, or a resin.

As illustrated in FIG. 1, the housing 10 has, for example, a box shape. The housing 10 has, for example, a substantially rectangular parallelepiped shape. The housing 10 includes the base 11 and the lid 18. The base 11 and the lid 18 constitute the housing 10.

As illustrated in FIG. 3, the base 11 has an opening 11a in which the sensor substrate 20 is located. In the illustrated example, the opening 11a opens in a +Z axis direction. The base 11 has a recessed shape.

As illustrated in FIG. 4, the base 11 has a bottom 12 and a side wall 15. Screw holes 13 for fixing the sensor substrate 20 to the base 11 are formed in the bottom 12. A plurality of the screw holes 13 is formed. Further, a through-opening 14 in which the connector 40 mounted on the sensor substrate 20 is disposed is formed in the bottom 12. The side wall 15 is erected from an edge of the bottom 12. Screw holes 16 for fixing the lid 18 to the base 11 are formed in an upper surface of the side wall 15. In the illustrated example, the screw holes 16 are formed one by one at diagonal corners of the base 11 when viewed in a Z-axis direction. Further, screw holes 17 for fixing the sensor module 100 to a mounted body are formed in the upper surface of the side wall 15. In the illustrated example, the screw holes 17 are formed one by one at diagonal corners of the base 11 when viewed in the Z-axis direction. The diagonal corners at which the screw holes 17 are formed are different from the diagonal corners at which the screw holes 16 are formed. The diameter of each screw hole 17 is, for example, larger than the diameters of the screw holes 13 and 16. The bottom 12 is provided with a first face 12a in which the screw holes 13 are formed and the sensor substrate 20 is disposed, and a second face 12b which is further recessed in a -Z axis direction than is the first face 12a. That is, the bottom 12 has the first face 12a and the second face 12b having different depths. As illustrated in FIG. 7, a member such as the second Z-axis angular velocity sensor 55z is disposed between the second face 12b of the bottom 12 and a second surface 22 of the sensor substrate 20.

The lid 18 is provided on the side wall 15 of the base 11. As illustrated in FIG. 1, the lid 18 has, for example, a plate shape. The lid 18 closes the opening 11a of the base 11. The lid 18 faces the sensor substrate 20 via the filling member 80. In the illustrated example, the lid 18 is fixed to the base 11 by screws 19. The screws 19 are inserted into the screw holes 16 illustrated in FIG. 4. The screws 19 are provided at diagonal corners of the lid 18 when viewed in the Z-axis direction. As a result, the lid 18 can be firmly fixed to the base 11. A method of connecting the lid 18 and the base 11 is not particularly limited, and may be welding or bonding using the filling member 80.

As illustrated in FIG. 3, the sensor substrate 20 is disposed in the housing 10. The sensor substrate 20 has a substantially rectangular shape when viewed in the Z-axis direction. The sensor substrate 20 is, for example, a circuit board. The sensor substrate 20 is, for example, a multilayer glass epoxy substrate or a multilayer ceramic substrate.

As illustrated in FIGS. 5 and 6, the sensor substrate 20 has a first surface 21, the second surface 22, a first side surface 23, and a second side surface 24. The first surface 21 and the second surface 22 have a front-back relation. In the illustrated example, the first surface 21 faces in the +Z axis direction. The second surface 22 faces in the -Z axis direction. The first side surface 23 and the second side surface 24 connect the first surface 21 and the second surface 22. The second side surface 24 faces in a direction orthogonal to the first side surface 23. In the illustrated example, the first side surface 23 faces in a -X axis direction. The second side surface 24 faces in a +Y axis direction.

The sensor substrate 20 includes a projecting portion 25 that connects the first side surface 23 and the second side surface 24. The projecting portion 25 projects further in the -X axis direction than the first side surface 23. Further, the projecting portion 25 projects further in the +Y axis direction than the second side surface 24. As illustrated in FIG. 5, the projecting portion 25 is provided at one of diagonal corners in a direction D1 of the sensor substrate 20 when viewed in the Z-axis direction. In the illustrated example, the direction D1 is a direction inclined by 45° with respect to the X-axis direction and the Y-axis direction. In addition, the projecting portion 25 is in contact with the first face 12a of the bottom 12 of the base 11. The projecting portion 25 is provided with a screw hole 27. The screw holes 13 are provided in the first face 12a of the bottom 12 of the base 11 with which the projecting portion 25 is in contact.

The sensor substrate 20 has cutouts 26 at diagonal corners in a direction D2 intersecting with the direction D1 when viewed in the Z-axis direction. In the illustrated example, the direction D2 is orthogonal to the direction D1. The cutouts 26 are provided one by one at the diagonal corners in the direction D2 of the sensor substrate 20. The cutouts 26 are provided, for example, in the direction D1. The cutouts 26 are provided in the vicinity of the screw holes 17. Side surfaces of the sensor substrate 20 constituting the cutouts 26 face the screw holes 17.

As illustrated in FIG. 6, screw holes 27 for fixing the sensor substrate 20 to the base 11 are formed in the sensor substrate 20. The screw holes 27 are in communication with the screw holes 13 formed in the base 11 illustrated in FIG. 4. A plurality of the screw holes 27 is formed. One of the plurality of screw holes 27 is formed in the projecting portion 25. In the example illustrated in FIG. 6, the screw holes 27 are provided at the diagonal corners in the direction D1 of the sensor substrate 20 and the diagonal corners in the direction D2 of the sensor substrate 20 when viewed in the Z-axis direction.

The fixing members 30 fix the sensor substrate 20 to the base 11. The fixing members 30 pass through the sensor substrate 20. The fixing members 30 are inserted into the screw holes 27 formed in the sensor substrate 20 and the screw holes 13 formed in the base 11. The fixing members 30 are, for example, screws. The fixing members 30 screw the sensor substrate 20 to the base 11.

A plurality of the fixing members 30 is provided corresponding to the pluralities of screw holes 13 and 27. In the example illustrated in FIG. 5, four fixing members 30 are provided as a first fixing member 30a, a second fixing member 30b, a third fixing member 30c, and a fourth fixing member 30d. The first fixing member 30a and the second fixing member 30b are disposed at diagonal corners in the direction D1 of the sensor substrate 20 when viewed in the Z-axis direction. The first fixing member 30a is inserted into the screw hole 27 formed in the projecting portion 25. The third fixing member 30c and the fourth fixing member 30d are disposed at diagonal corners in the direction D2 of the sensor substrate 20 when viewed in the Z-axis direction. The number of the fixing members 30 is not particularly limited as long as it is two or more.

As illustrated in FIG. 7, the connector 40 is provided on the second surface 22 of the sensor substrate 20. The connector 40 is, for example, a plug-type connector. The connector 40 is exposed to the outside of the sensor module 100 through the through-opening 14 formed in the base 11. Therefore, electrical connection between the sensor module 100 and an external device (not illustrated) is facilitated.

As illustrated in FIGS. 5 and 6, the first X-axis angular velocity sensor 50x, the second X-axis angular velocity sensor 51x, the first Y-axis angular velocity sensor 52y, the second Y-axis angular velocity sensor 53y, the first Z-axis angular velocity sensor 54z, and the second Z-axis angular velocity sensor 55z are mounted on the sensor substrate 20. The angular velocity sensors 50x, 51x, 52y, 53y, 54z, and 55z are mounted on the sensor substrate 20. The angular velocity sensors 50x, 51x, 52y, 53y, 54z, and 55z are packaged surface-mounted components. As a result, the angular velocity sensors 50x, 51x, 52y, 53y, 54z, and 55z can have high mechanical strength compared to a mounted component in which an element is exposed. Further, the angular velocity sensors 50x, 51x, 52y, 53y, 54z, and 55z can be easily mounted on the sensor substrate 20.

The first X-axis angular velocity sensor 50x, the second X-axis angular velocity sensor 51x, the first Y-axis angular velocity sensor 52y, the second Y-axis angular velocity sensor 53y, the first Z-axis angular velocity sensor 54z, and the second Z-axis angular velocity sensor 55z have sensor elements formed of, for example, quartz crystal vibration elements. The angular velocity sensors 50x, 51x, 52y, 53y, 54z, and 55z basically have the same configuration except that the vibration frequencies of the sensor elements are different from each other in order to suppress mutual interference, and are disposed in postures orthogonal to each other such that the detection axes are directed to the X-axis, the Y-axis, and the Z-axis. The sensor elements may be silicon micro electro mechanical systems (MEMS) vibration elements instead of the quartz crystal vibration elements. All the vibration frequencies of the sensor elements of the angular velocity sensors 50x, 51x, 52y, 53y, 54z, and 55z may be different from each other, or some of the vibration frequencies may be the same. For example, the vibration frequency of the sensor element of the first X-axis angular velocity sensor 50x may be different from that of the second X-axis angular velocity sensor 51x, the vibration frequency of the sensor element of the first Y-axis angular velocity sensor 52y may be different from that of the second Y-axis angular velocity sensor 53y, and the vibration frequency of the sensor element of the first Z-axis angular velocity sensor 54z may be different from that of the second Z-axis angular velocity sensor 55z. For example, the vibration frequencies of the sensor elements of the angular velocity sensors 50x and 54z may be the same.

The first X-axis angular velocity sensor 50x and the second X-axis angular velocity sensor 51x are disposed on the first side surface 23 of the sensor substrate 20. The X-axis angular velocity sensors 50x and 51x are arranged in the Y-axis direction on the first side surface 23. The X-axis angular velocity sensors 50x and 51x are located between the sensor substrate 20 and the side wall 15 of the base 11. The X-axis angular velocity sensors 50x and 51x are separated from the side wall 15. As illustrated in FIG. 7, the X-axis angular velocity sensors 50x and 51x are longer than the sensor substrate 20 in the Z-axis direction, and project to both upper and lower sides of the sensor substrate 20. The X-axis angular velocity sensors 50x and 51x detect an angular velocity around the X-axis.

As illustrated in FIGS. 5 and 6, the first Y-axis angular velocity sensor 52y and the second Y-axis angular velocity sensor 53y are disposed on the second side surface 24 of the sensor substrate 20. The Y-axis angular velocity sensors 52y and 53y are arranged in the X-axis direction on the second side surface 24. The Y-axis angular velocity sensors 52y and 53y are located between the sensor substrate 20 and the side wall 15 of the base 11. The Y-axis angular velocity sensors 52y and 53y are separated from the side wall 15. The Y-axis angular velocity sensors 52y and 53y are longer than the sensor substrate 20 in the Z-axis direction and project to both the upper and lower sides of the sensor substrate 20. The Y-axis angular velocity sensors 52y and 53y detect an angular velocity around the Y-axis.

As illustrated in FIG. 5, the first Z-axis angular velocity sensor 54z is disposed on the first surface 21 of the sensor substrate 20. The first Z-axis angular velocity sensor 54z is located between the sensor substrate 20 and the lid 18. The first Z-axis angular velocity sensor 54z is separated from the lid 18. As illustrated in FIG. 6, the second Z-axis angular velocity sensor 55z is disposed on the second surface 22 of the sensor substrate 20. The second Z-axis angular velocity sensor 55z is located between the sensor substrate 20 and the bottom 12 of the base 11. The second Z-axis angular velocity sensor 55z is separated from the bottom 12. The Z-axis angular velocity sensors 54z and 55z overlap with each other, for example, when viewed in the Z-axis direction. The Z-axis angular velocity sensors 54z and 55z detect an angular velocity around the Z-axis.

As illustrated in FIG. 5, the circuit element 60 is mounted on the sensor substrate 20. The circuit element 60 is disposed on the first surface 21 of the sensor substrate 20. The circuit element 60 is electrically connected to the angular velocity sensors 50x, 51x, 52y, 53y, 54z, and 55z via the sensor substrate 20. The circuit element 60 is, for example, a micro controller unit (MCU). The circuit element 60 integrally controls each unit of the sensor module 100. Specifically, the circuit element 60 includes a control circuit that controls driving of the angular velocity sensors 50x, 51x, 52y, 53y, 54z, and 55z and an interface circuit that performs communication with the outside.

The control circuit of the circuit element 60 independently controls the driving of the angular velocity sensors 50x, 51x, 52y, 53y, 54z, and 55z, and independently detects the angular velocity around each of the X-axis, the Y-axis, and the Z-axis based on detection signals output from the angular velocity sensors 50x, 51x, 52y, 53y, 54z, and 55z. The control circuit averages the detection signal output from the first X-axis angular velocity sensor 50x and the detection signal output from the second X-axis angular velocity sensor 51x to detect the angular velocity around the X-axis. Further, the control circuit averages the detection signal output from the first Y-axis angular velocity sensor 52y and the detection signal output from the second Y-axis angular velocity sensor 53y to detect the angular velocity around the Y-axis. Further, the control circuit averages the detection signal output from the first Z-axis angular velocity sensor 54z and the detection signal output from the second Z-axis angular velocity sensor 55z to detect the angular velocity around the Z-axis.

The interface circuit of the circuit element 60 transmits and receives a signal, receives a command from an external device, and outputs the detected angular velocity and acceleration to the external device. A communication method of the interface circuit is not particularly limited, and for example, serial peripheral interface (SPI) communication is exemplified. The SPI communication is a communication method suitable for connecting a plurality of sensors. In the SPI communication, all signals relating to the angular velocity and the acceleration can be output from one pin, and thus it is possible to achieve pin saving of the sensor module 100.

The acceleration sensors 70 are mounted on the sensor substrate 20. For example, a plurality of the acceleration sensors 70 is provided. In the illustrated example, four acceleration sensors 70 are provided. Two of the four acceleration sensors 70 are disposed on the first surface 21 of the sensor substrate 20. The other two of the four acceleration sensors 70 are disposed on the second surface 22 of the sensor substrate 20.

Each acceleration sensor 70 is a three-axis acceleration sensor capable of independently detecting acceleration in the X-axis direction, acceleration in the Y-axis direction, and acceleration in the Z-axis direction. Each of the plurality of acceleration sensors 70 includes a package and three sensor elements accommodated in the package. The three sensor elements are a sensor element for detecting the acceleration in the X-axis direction, a sensor element for detecting the acceleration in the Y-axis direction, and a sensor element for detecting the acceleration in the Z-axis direction. The three sensor elements are, for example, MEMS vibration elements. The acceleration sensor 70 is electrically connected to the sensor substrate 20 via a connection terminal disposed in the package.

A plurality of electronic components other than the angular velocity sensors 50x, 51x, 52y, 53y, 54z, and 55z, the circuit element 60, and the acceleration sensors 70 described above may be mounted on the sensor substrate 20.

As illustrated in FIGS. 2 and 7, the filling member 80 is accommodated in the housing 10. The opening 11a of the base 11 is filled with the filling member 80. Portions between the sensor substrate 20 and the housing 10 are filled with the filling member 80. The filling member 80 is located between the first surface 21 of the sensor substrate 20 and the lid 18, between the second surface 22 of the sensor substrate 20 and the bottom 12 of the base 11, and between a side surface of the sensor substrate 20 and the side wall 15 of the base 11. In the filling member 80, the thickness of the portion between the first surface 21 and the lid 18 and the thickness of the portion between the second surface 22 and the bottom 12 may be the same.

The filling member 80 is located between the first X-axis angular velocity sensor 50x and the side wall 15, between the second X-axis angular velocity sensor 51x and the side wall 15, between the first Y-axis angular velocity sensor 52y and the side wall 15, between the second Y-axis angular velocity sensor 53y and the side wall 15, between the first Z-axis angular velocity sensor 54z and the lid 18, and between the second Z-axis angular velocity sensor 55z and the bottom 12.

The filling member 80 covers the sensor substrate 20. The filling member 80 further covers the angular velocity sensors 50x, 51x, 52y, 53y, 54z, and 55z. Specifically, the filling member 80 covers the entire first X-axis angular velocity sensor 50x, the entire second X-axis angular velocity sensor 51x, the entire first Y-axis angular velocity sensor 52y, the entire second Y-axis angular velocity sensor 53y, the entire first Z-axis angular velocity sensor 54z, and the entire second Z-axis angular velocity sensor 55z. In other words, the filling member 80 covers the angular velocity sensors 50x, 51x, 52y, 53y, 54z, and 55z without a gap. The filling member 80 covers the entire region of the first X-axis angular velocity sensor 50x other than the region mounted on the sensor substrate 20. Similarly, the filling member 80 covers the entire regions of the angular velocity sensors 51x, 52y, 53y, 54z, and 55z other than the regions mounted on the sensor substrate 20. The filling member 80 further covers the circuit element 60 and the acceleration sensor 70.

As illustrated in FIGS. 2 and 8, the filling member 80 covers the fixing members 30. Specifically, the filling member 80 covers the entire fixing members 30. In other words, the filling member 80 covers the fixing members 30 without a gap. In the example illustrated in FIG. 8, the filling member 80 covers the entire region of each fixing member 30 other than the region of the fixing member 30 in contact with the sensor substrate 20 and the region of the fixing member 30 in contact with the base 11.

The filling member 80 is, for example, a potting material. The filling member 80 is made of, for example, a material that is hard, has a low hygroscopic property, and has a small thermal expansion coefficient. Specifically, the filling member 80 is made of a thermosetting epoxy adhesive. The hardness of the filling member 80 is, for example, 80 D or more, and preferably 90 D or more by a type D durometer in a JIS 7215-1986 durometer hardness test. The filling member 80 may be made of an epoxy adhesive containing various fillers. As a result, the hardness and the thermal expansion coefficient of the filling member 80 can be easily adjusted by the fillers.

### 1.2. Manufacturing Method

As a method of manufacturing the sensor module 100, first, as illustrated in FIG. 4, the base 11 is prepared. Next, as illustrated in FIG. 3, the sensor substrate 20 on which the angular velocity sensors 50x, 51x, 52y, 53y, 54z, and 55z and the like are mounted is fixed to the base 11 by the fixing members 30. Next, as illustrated in FIG. 2, the opening 11a of the base 11 is filled with the filling member 80 such that the sensor substrate 20 and the fixing member 30 are embedded. Next, the filling member 80 is cured by heat treatment. Since the sensor substrate 20 is fixed to the base 11 by a plurality of the fixing members 30, it is possible to reduce distortion which occurs in the sensor substrate 20 due to stress when the filling member 80 is cured. Next, as illustrated in FIG. 1, the lid 18 is fixed to the base 11 by the screws 19.

### The sensor module 100 can be manufactured by the steps described above.

1.3. Effects

The sensor module 100 includes the base 11 and the lid 18 constituting the housing 10, the sensor substrate 20 that is disposed in the housing 10 and on which the first Z-axis angular velocity sensor 54z as a first sensor is mounted, the two or more fixing members 30 that fix the sensor substrate 20 to the base 11, and the filling member 80 that covers the sensor substrate 20 and the two or more fixing members 30 and with which a portion between the sensor substrate 20 and the housing 10 is filled. Therefore, in the sensor module 100, compared to a case where the fixing members are not covered with the filling member, it is possible to reduce the possibility that the sensor substrate 20 is distorted according to the external environment. Further, it is possible to reduce the possibility that the fixing members 30 are loosened due to an impact or the like.

In the sensor module 100, the base 11 has the opening 11a in which the sensor substrate 20 is located and that opens in the +Z axis direction as a first direction, and the lid 18 closes the opening 11a and faces the sensor substrate 20 via the filling member 80. Therefore, in the sensor module 100, the structure of the housing 10 can be simplified, and, for example, the area of the sensor substrate 20 can be increased. As a result, the number of sensors mounted on the sensor substrate 20 can be increased.

In the sensor module 100, when viewed in the +Z axis direction, the two or more fixing members 30 are disposed at the diagonal corners in the direction D1 as a second direction of the sensor substrate 20. Therefore, in the sensor module 100, the sensor substrate 20 can be firmly fixed to the base 11 by the fixing members 30.

In the sensor module 100, the sensor substrate 20 has the cutouts 26 at the diagonal corners in the direction D2 as a third direction intersecting with the direction D1. Therefore, in the sensor module 100, the screw holes 17 for mounting the sensor module 100 on the mounted body can be provided in the vicinity of the cutouts 26.

In the sensor module 100, the sensor substrate 20 includes the first side surface 23 facing in the -X axis direction as a fourth direction, the second side surface 24 facing in the +Y axis direction as a fifth direction, and the projecting portion 25 connecting the first side surface 23 and the second side surface 24, projecting further in the -X axis direction than the first side surface 23, and projecting further in the +Y direction than the second side surface 24, the first X-axis angular velocity sensor 50x as a second sensor is disposed on the first side surface 23, and the first Y-axis angular velocity sensor 52y as a third sensor is disposed on the second side surface 24. Therefore, in the sensor module 100, it is possible to secure a space between the first side surface 23 and the base 11 and a space between the second side surface 24 and the base 11 by the projecting portion 25. Further, the first X-axis angular velocity sensor 50x can be disposed in the space between the first side surface 23 and the base 11, and the first Y-axis angular velocity sensor 52y can be disposed in the space between the second side surface 24 and the base 11.

In the sensor module 100, the filling member 80 covers the entire first X-axis angular velocity sensor 50x, the entire first Y-axis angular velocity sensor 52y, and the entire first Z-axis angular velocity sensor 54z. Therefore, in the sensor module 100, it is possible to equalize the stresses caused by the filling member 80 in the angular velocity sensors 50x, 52y, and 54z. As a result, the characteristics of the angular velocity sensors 50x, 52y, and 54z can be equalized. For example, in a case where one angular velocity sensor is entirely covered with the filling member, and the other angular velocity sensor is covered with the filling member only by approximately a half thereof, the stresses caused by the filling member in both the angular velocity sensors are different, and a difference in characteristics occurs.

In the sensor module 100, the sensor substrate 20 includes the first surface 21 and the second surface 22 having a front-back relation, the first Z-axis angular velocity sensor 54z is disposed on the first surface 21, and the second Z-axis angular velocity sensor 55z as a fourth sensor is disposed on the second surface 22. Therefore, in the sensor module 100, it is possible to improve the detection accuracy compared to a case where only one Z-axis angular velocity sensor is provided.

In the sensor module 100, the second X-axis angular velocity sensor 51x as a fifth sensor is disposed on the first side surface 23, and the second Y-axis angular velocity sensor 53y as a sixth sensor is disposed on the second side surface 24. Therefore, in the sensor module 100, it is possible to improve the detection accuracy compared to a case where only one X-axis angular velocity sensor and only one Y-axis angular velocity sensor are provided. For example, when two X-axis angular velocity sensors, two Y-axis angular velocity sensors, and two Z-axis angular velocity sensors are provided, noise characteristics can be improved by 1/(√2) times compared to a case where only one X-axis angular velocity sensor, only one Y-axis angular velocity sensor, and only one Z-axis angular velocity sensor are provided.

### 2. Modification of Sensor Module

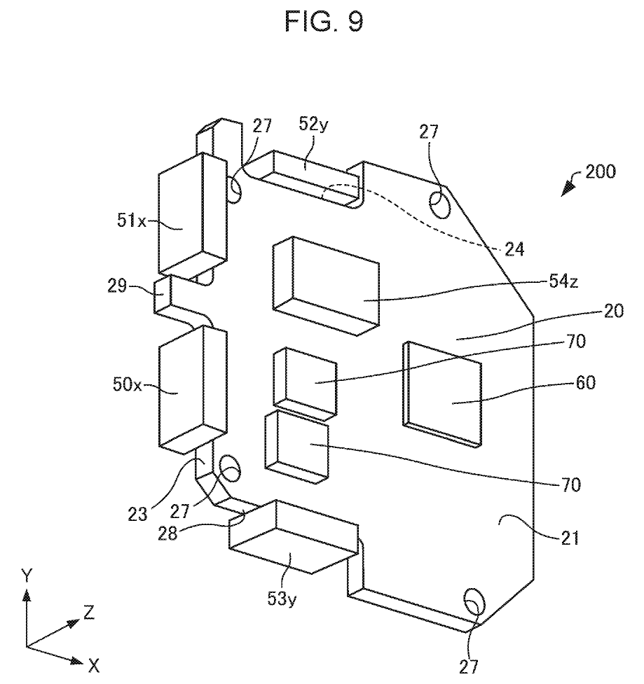

Next, a sensor module according to a modification of the present embodiment will be described with reference to the drawings. FIG. 9 is a perspective view schematically illustrating a sensor module 200 according to the modification of the present embodiment. For convenience, the housing 10, the fixing members 30, and the filling member 80 are not illustrated in FIG. 9.

Hereinafter, in the sensor module 200 according to the modification of the present embodiment, members having the same functions as those of the constituent members of the sensor module 100 according to the present embodiment described above are denoted by the same reference numerals, and the detailed description thereof will be omitted.

In the sensor module 100 described above, as illustrated in FIG. 5, the second Y-axis angular velocity sensor 53y is disposed on the second side surface 24 of the sensor substrate 20.

In contrast, in the sensor module 200, as illustrated in FIG. 9, the second Y-axis angular velocity sensor 53y is disposed on a third side surface 28 of the sensor substrate 20. The third side surface 28 of the sensor substrate 20 faces a direction opposite to the second side surface 24. In the illustrated example, the third side surface 28 faces in a -Y axis direction.

The sensor substrate 20 has a projecting portion 29 between the first X-axis angular velocity sensor 50x and the second X-axis angular velocity sensor 51x. The projecting portion 29 projects further in the -X axis direction than the X-axis angular velocity sensors 50x and 51x. The projecting portion 29 is in contact with the side wall 15 of the base 11. A space can be secured between the first side surface 23 and the side wall 15 by the projecting portion 29, and the X-axis angular velocity sensors 50X and 51X can be disposed in the space.

The sensor module 200 includes the first side surface 23 facing in the -X axis direction as a fourth direction, the second side surface 24 facing in the +Y axis direction as a fifth direction, and the third side surface 28 facing in the -Y axis direction as a sixth direction. The first X-axis angular velocity sensor 50x as a second sensor and the second X-axis angular velocity sensor 51x as a third sensor are disposed on the first side surface 23, the first Y-axis angular velocity sensor 52y as a fourth sensor is disposed on the second side surface 24, and the second Y-axis angular velocity sensor 53y as a fifth sensor is disposed on the third side surface 28. Therefore, in the sensor module 200, it is possible to improve the detection accuracy compared to a case where only one X-axis angular velocity sensor and only one Y-axis angular velocity sensor are provided.

The above-described embodiment and modification are merely examples, and the present disclosure is not limited thereto. For example, the embodiment and the modification may be combined as appropriate.

The present disclosure includes configurations substantially the same as the configurations described in the embodiment, for example, configurations having the same function, method, and result or configurations having the same purpose and effect. Further, the present disclosure includes configurations in which non-essential portions of the configurations described in the embodiment are replaced. In addition, the present disclosure includes configurations that achieve the same effects as the configurations described in the embodiment or configurations capable of achieving the same object. Furthermore, the present disclosure includes configurations in which a known technique is added to the configurations described in the embodiment.

The following contents are derived from the above-described embodiment and modification.

According to an aspect of the present disclosure, a sensor module includes a base and a lid constituting a housing, a sensor substrate that is disposed in the housing and on which a first sensor is mounted, two or more fixing members that fix the sensor substrate to the base, and a filling member that covers the sensor substrate and the two or more fixing members and with which a portion between the sensor substrate and the housing is filled.

According to the sensor module, it is possible to reduce the possibility that the sensor substrate is distorted.

In the aspect of the sensor module, the base may have an opening in which the sensor substrate is located and that opens in a first direction, and the lid may close the opening and face the sensor substrate via the filling member.

According to the sensor module, it is possible to simplify the structure of the housing.

In the aspect of the sensor module, when viewed in the first direction, the two or more fixing members may be disposed at diagonal corners in a second direction of the sensor substrate.

According to the sensor module, the sensor substrate can be firmly fixed to the base by the fixing members.

In the aspect of the sensor module, the sensor substrate may have cutouts at diagonal corners in a third direction intersecting with the second direction.

According to the sensor module, screw holes for mounting the sensor module on the mounted body can be provided in the vicinity of the cutouts.

In the aspect of the sensor module, the sensor substrate may include a first side surface facing in a fourth direction orthogonal to the first direction, a second side surface facing in a fifth direction orthogonal to the first direction and the fourth direction, and a projecting portion connecting the first side surface and the second side surface, projecting further in the fourth direction than the first side surface, and projecting further in the fifth direction than the second side surface, a second sensor may be disposed on the first side surface, and a third sensor may be disposed on the second side surface.

According to the sensor module, it is possible to secure a space between the first side surface and the base and a space between the second side surface and the base by the projecting portion.

In the aspect of the sensor module, the filling member may cover the entire first sensor, the entire second sensor, and the entire third sensor.

According to the sensor module, it is possible to equalize the stresses caused by the filling member in the first sensor, the second sensor, and the third sensor.

In the aspect of the sensor module, the sensor substrate may include a first surface and a second surface having a front-back relation, the first sensor may be disposed on the first surface, and a fourth sensor may be disposed on the second surface.

According to the sensor module, the detection accuracy can be improved.

In the aspect of the sensor module, a fifth sensor may be disposed on the first side surface, and a sixth sensor may be disposed on the second side surface.

According to the sensor module, the detection accuracy can be improved.

In the aspect of the sensor module, the sensor substrate may include a first side surface facing in a fourth direction orthogonal to the first direction, a second side surface facing in a fifth direction orthogonal to the first direction and the fourth direction, and a third side surface facing in a sixth direction opposite to the fifth direction, a second sensor and a third sensor may be disposed on the first side surface, a fourth sensor may be disposed on the second side surface, and a fifth sensor may be disposed on the third side surface.

According to the sensor module, the detection accuracy can be improved.

What is claimed is:

1. A sensor module comprising:
a base and a lid constituting a housing;
a sensor substrate that is disposed in the housing and on which a first sensor is mounted;
two or more fixing members that fix the sensor substrate to the base; and
a filling member that covers the sensor substrate and the two or more fixing members and with which a portion between the sensor substrate and the housing is filled.

2. The sensor module according to claim 1, wherein
the base has an opening in which the sensor substrate is located and that opens in a first direction, and
the lid closes the opening and faces the sensor substrate via the filling member.

3. The sensor module according to claim 2, wherein
when viewed in the first direction, the two or more fixing members are disposed at diagonal corners in a second direction of the sensor substrate.

4. The sensor module according to claim 3, wherein
the sensor substrate has cutouts at diagonal corners in a third direction intersecting with the second direction.

5. The sensor module according to claim 2, wherein
the sensor substrate includes
a first side surface facing in a fourth direction orthogonal to the first direction,
a second side surface facing in a fifth direction orthogonal to the first direction and the fourth direction, and
a projecting portion connecting the first side surface and the second side surface, projecting further in the fourth direction than the first side surface, and projecting further in the fifth direction than the second side surface,
a second sensor is disposed on the first side surface, and
a third sensor is disposed on the second side surface.

6. The sensor module according to claim 5, wherein
the filling member covers the entire first sensor, the entire second sensor, and the entire third sensor.

7. The sensor module according to claim 5, wherein
the sensor substrate includes a first surface and a second surface having a front-back relation,
the first sensor is disposed on the first surface, and
a fourth sensor is disposed on the second surface.

8. The sensor module according to claim 7, wherein
a fifth sensor is disposed on the first side surface, and
a sixth sensor is disposed on the second side surface.

9. The sensor module according to claim 2, wherein
the sensor substrate includes
a first side surface facing in a fourth direction orthogonal to the first direction,
a second side surface facing in a fifth direction orthogonal to the first direction and the fourth direction, and
a third side surface facing in a sixth direction opposite to the fifth direction,
a second sensor and a third sensor are disposed on the first side surface,
a fourth sensor is disposed on the second side surface, and
a fifth sensor is disposed on the third side surface.
